(19) United States
(12) Patent Application Publication
(10) Pub. No.: US 2007/0111103 A1
(43) Pub. Date: May 17, 2007

(54) CURRENT COLLECTOR, ANODE, AND BATTERY

(76) Inventors: Isamu Konishiike, Fukushima (JP); Kotaro Satori, Kanagawa (JP); Kenichi Kawase, Fukushima (JP); Takakazu Hirose, Fukushima (JP); Masayuki Iwama, Fukushima (JP)

Correspondence Address: David R. Metzeger;SONNENSCHEIN NATH & ROSENTHAL LLP, Wacker Drive Station, Sears Tower, Post Office Box 0, Chicago, IL, 60606-1080, US

(21) Appl. No.: 11/559,123

(22) Filed: Nov. 13, 2006

(30) Foreign Application Priority Data
Nov. 14, 2005 (JP) P2005-328545

(51) Int. Cl. H01M 4/66; H01M 4/58; H01B 1/02

(52) U.S. Cl. 429/245; 429/218.1; 428/544

(57) ABSTRACT

A current collector capable of relaxing stress and of improving charcteristics, an anode using the current collector, and a battery using the current collector are provided. An active material layer containing Si is provided on a current collector. The current collector contains Cu. Where a peak area resulting from (220) crystal face of Cu obtained by X-ray diffraction is I₂₂₀, and a peak area resulting from (200) crystal face of Cu obtained by X-ray diffraction is I₂₀₀, ratio I₂₂₀/I₂₀₀ as a ratio of the peak area I₂₀₀ to the peak area I₂₀₀ is 2.5 or less. Thereby, even when the active material layer is expanded and shrunk due to charge and discharge, the stress can be relaxed, and separation or the like of the active material layer can be prevented.

### CROSS REFERENCES TO RELATED APPLICATIONS

The present invention contains subject matter related to Japanese Patent Application JP 2005-328545 filed in the Japanese Patent Office on Nov. 14, 2005, the entire contents of which being incorporated herein by reference.

### BACKGROUND OF THE INVENTION

1. Field of the Invention

The present invention relates to a current collector containing copper (Cu) as an element, an anode using the current collector, and a battery using the current collector.

2. Description of the Related Art

In recent years, as mobile devices have been sophisticated and multi-functionalized, a higher capacity of secondary batteries as a power source for these mobile devices has been demanded. As a secondary battery to meet such a demand, there is a lithium ion secondary battery. However, since graphite is used for the anode in the lithium ion secondary battery in practical use currently, the battery capacity thereof is in a saturated state and thus it is difficult to attain a vastly high capacity thereof. Therefore, it is considered to use silicon or the like for the anode. Recently, forming an active material layer on a current collector by vapor-phase deposition method or the like has been reported. Silicon or the like is largely expanded and shrunk due to charge and discharge, and thus there has been a disadvantage that the cycle characteristics are lowered due to pulverization. However, when using the vapor-phase deposition method or the like, such pulverization can be prevented, and the current collector and the active material layer can be integrated. In the result, electron conductivity in the anode becomes extremely favorable, and high performance both in the capacity and the cycle life is expected.

However, even in the anode in which the current collector and the active material layer are integrated, there has been a disadvantage as follows. That is, when charge and discharge are repeated, stress is applied between the current collector and the active material layer by intense expansion and shrinkage of the active material layer, leading to separation or the like of the active material layer and deformation of the current collector, and thus the cycle characteristics are lowered. Therefore, it has been reported that a tensile strength of the current collector is set to a given value or more, or that elongation of the current collector is set to a given value or more (for example, refer to International Publication No. WO01/029912 and Japanese Unexamined Patent Application Publication No. 2005-135856).

### SUMMARY OF THE INVENTION

However, expansion and shrinkage of an active material due to cycles are generated microscopically. Therefore, there is low correlation between macroscopic physical characteristics of a current collector such as a tensile strength and elongation percentage and cycle characteristics. In the result, there has been a disadvantage that even when such macroscopic physical characteristics are controlled, the characteristics are not improved sufficiently.

In view of the foregoing, in the invention, it is desirable to provide a current collector capable of relaxing stress, of preventing deformation, and thereby improving characteristics, an anode using the current collector, and a battery using the current collector.

According to an embodiment of the invention, there is provided a current collector containing copper as an element, wherein where a peak area resulting from (220) crystal face of copper obtained by X-ray diffraction is I₂₂₀, and a peak area resulting from (200) crystal face of copper obtained by X-ray diffraction is I₂₀₀, ratio I₂₂₀/I₂₀₀ as a ratio of the peak area I₂₂₀ to the peak area I₂₀₀ is 2.5 or less at least in part.

According to an embodiment of the invention, there is provided an anode provided with an active material layer on a current collector, wherein the current collector contains copper as an element, and where a peak area resulting from (220) crystal face of copper obtained by X-ray diffraction is I₂₂₀, and a peak area resulting from (200) crystal face of copper obtained by X-ray diffraction is I₂₀₀, ratio I₂₂₀/I₂₀₀ as a ratio of the peak area I₂₂₀ to the peak area I₂₀₀ is 2.5 or less at least in part.

According to an embodiment of the invention, there is provided a battery including a cathode, an anode, and an electrolyte, wherein the anode has a current collector and an active material layer, the current collector contains copper as an element, and where a peak area resulting from (220) crystal face of copper obtained by X-ray diffraction is I₂₂₀, and a peak area resulting from (200) crystal face of copper obtained by X-ray diffraction is I₂₀₀, ratio I₂₂₀/I₂₀₀ as a ratio of the peak area I₂₂₀ to the peak area I₂₀₀ is 2.5 or less at least in part.

According to the current collector of the embodiment of the invention, the ratio I₂₂₀/I₂₀₀ as a ratio of the peak area I₂₂₀ to the peak area I₂₀₀ is 2.5 or less at least in part. Therefore, stress due to expansion and shrinkage can be relaxed, and deformation can be prevented. Therefore, according to the anode and the battery of the embodiments of the invention, separation or the like can be prevented, and battery characteristics such as a capacity and cycle characteristics can be improved.

Other and further objects, features and advantages of the invention will appear more fully from the following description.

### BRIEF DESCRIPTION OF THE DRAWINGS

FIG. 1 is a cross section showing a structure of an anode according to an embodiment of the invention;

FIG. 2 is a cross section showing a structure of a secondary battery using the anode shown in FIG. 1;

FIG. 3 is an exploded perspective view showing another structure of a secondary battery using the anode shown in FIG. 1; and

FIG. 4 is a cross section showing a structure taken along line I-I of the secondary battery shown in FIG. 3.

### DETAILED DESCRIPTION OF THE PREFERRED EMBODIMENT

An embodiment of the invention will be hereinafter described in detail with reference to the drawings.

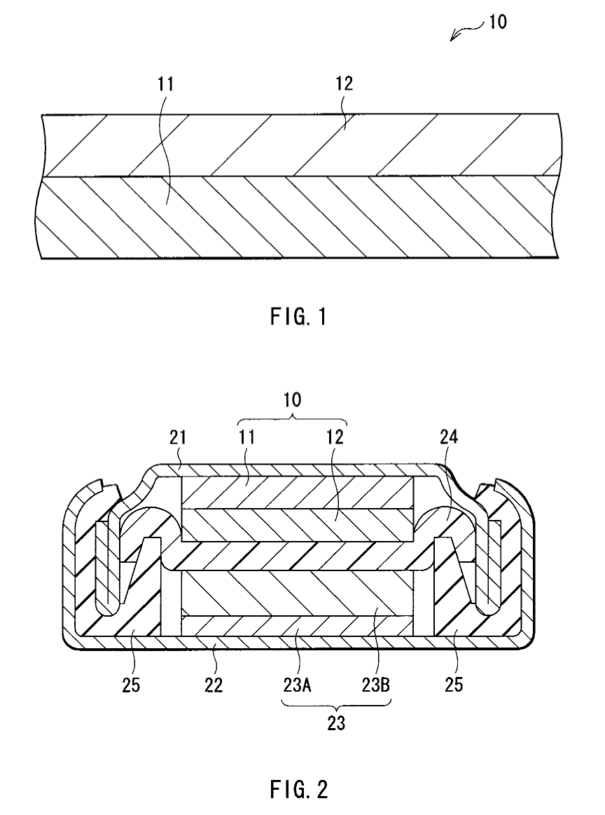

FIG. 1 shows a structure of an anode 10 according to an embodiment of the invention. For example, the anode 10 has a current collector 11 and an active material layer 12 provided on the current collector 11. The active material layer 12 may be provided on one face of the current collector 11, or the both faces thereof.

The current collector 11 is made of a material containing copper as an element. Copper has high conductivity and high stability. The current collector 11 may be made of simple substance of copper or an alloy of copper. The current collector 11 may be made of a single layer or a plurality of layers. It is enough that the current collector 11 is made of a material containing copper as an element in part.

Where a peak area resulting from (220) crystal face of copper obtained by X-ray diffraction is I₂₂₀, and a peak area resulting from (200) crystal face of copper obtained by X-ray diffraction is I₂₀₀, the current collector 11 has ratio I₂₂₀/I₂₀₀ as a ratio of the peak area I₂₂₀ to the peak area I₂₀₀ is 2.5 or less at least in part. Thereby, even when the active material layer 12 is largely expanded and shrunk due to charge and discharge, the stress can be relaxed, and the current collector 11 can be prevented from being deformed. The ratio I₂₂₀/I₂₀₀ is preferably from 0.03 to 2.5 at least in part, since thereby higher effects can be obtained. The ratio I₂₂₀/I₂₀₀ can be controlled by adjusting forming conditions of the current collector 11, or by providing heat treatment after forming the current collector 11.

The surface roughness of the current collector 11 on which the active material layer 12 is provided is, based on ten point height of roughness profile Rz described in JIS B0601, preferably 1 μm or more, more preferably 9 μm or less, and much more preferably in the range from 1.3 μm to 3.5 μm. Thereby, contact characteristics with the active material layer 12 can be improved. The surface roughness of the current collector 11 may be adjusted by roughening the surface by lapping, for example. Otherwise, the surface roughness of the current collector 11 may be adjusted by forming granular protrusions by plating, vapor deposition or the like. Providing the protrusions on the surface is preferable, since thereby higher effects can be obtained. While the protrusions are preferably made of a material containing copper as an element, the protrusions may be made of other material.

The active material layer 12 contains, for example, an active material containing an element capable of forming an alloy with lithium (Li). The element capable of forming an alloy with lithium may be contained in the form of a simple substance, an alloy, or a compound. Specially, the active material layer 12 preferably contains an active material containing silicon (Si) as an element. Silicon has a high ability to insert and extract lithium, and can provide a high energy density. In this specification, alloys include an alloy of one or more metal elements and one or more metalloid elements, in addition to an alloy containing two or more metal elements.

The active material layer 12 is, at least in part, preferably formed by, for example, one or more methods selected from the group consisting of vapor-phase deposition method, spraying method, and firing method, or may be formed by a combination of two or more methods thereof. Thereby, deformation due to expansion and shrinkage of the active material layer 12 due to charge and discharge can be prevented. In addition, the current collector 11 and the active material layer 12 can be integrated, and electron conductivity in the active material layer 12 can be improved. “Firing method” means a method in which a layer formed from a mixture of powder containing an active material and a binder is heat-treated under the non-oxidizing atmosphere and thereby a denser layer with a higher volume density than the layer before heat treatment is formed.

The active material layer 12 may be formed by coating, more specifically, may be a layer containing an active material and if necessary, a binder such as polyvinylidene fluoride. However, as described above, the layer formed by vapor-phase deposition method, spraying method, or firing method at least in part is more preferable.

The active material layer 12 is preferably alloyed with the current collector 11 in at least part of the interface with the current collector 11. Specifically, in the interface, the element of the current collector 11 is preferably diffused in the active material layer 12, or the element of the active material layer 12 is preferably diffused in the current collector 11, or the both elements thereof are preferably diffused in each other. Thereby, the contact characteristics can be more improved. In this application, the foregoing diffusion of elements is regarded as one form of alloying.

The anode 10 can be formed as follows, for example.

For example, when the current collector 11 is formed by plating, the crystallinity is controlled by adjusting a plating current density, plating bath temperatures, plating bath additives or the like so that the ratio I₂₂₀/I₂₀₀ falls within a given range. Further, the crystallinity may be controlled by providing heat treatment after forming the current collector 11. When the current collector 11 is formed by rolling, for example, crystallinity of an ingot as a raw material is adjusted or heat treatment is performed, so that the ratio I₂₂₀/I₂₀₀ falls within a given range. If necessary, after the current collector 11 is formed, the surface thereof is roughed. Such roughening may be provided before or after heat treatment.

Next, the active material layer 12 is formed on the current collector 11 by vapor-phase deposition method, spraying method, firing method, coating or the like. The active material layer 12 may be formed by combination of two or more methods thereof. As vapor-phase deposition method, for example, physical deposition method or chemical deposition method can be cited. Specifically, vacuum vapor deposition method, sputtering method, ion plating method, laser ablation method, CVD (Chemical Vapor Deposition) method or the like can be cited. In some cases, the active material layer 12 and the current collector 11 are alloyed concurrently when the active material layer 12 is formed. However, it is possible that after the active material layer 12 is formed, heat treatment is performed under the vacuum atmosphere or under the non-oxidizing atmosphere to alloy the active material layer 12 and the current collector 11. Thereby, the anode 10 shown in FIG. 1 is obtained.

The anode 10 is used for the secondary battery as follows, for example.

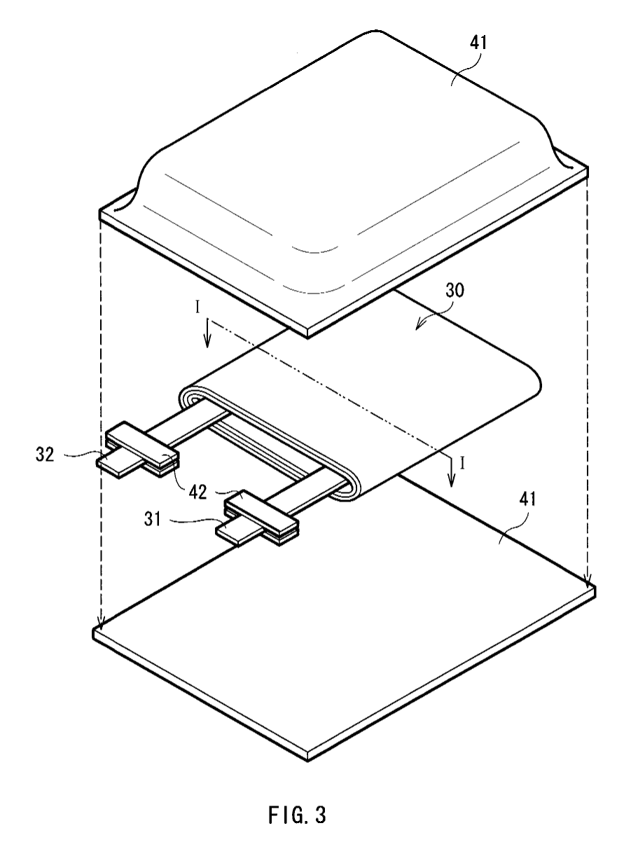

FIG. 2 shows a structure of the secondary battery. The secondary battery is a so-called coin-type secondary battery in which the anode 10 contained in a package cup 21 and a cathode 23 contained in a package can 22 are layered with a separator 24 in between.

Peripheral edges of the package cup 21 and the package can 22 are hermetically sealed by being caulked with an insulating gasket 25. The package cup 21 and the package can 22 are respectively made of a metal such as stainless and aluminum.

The cathode 23 has, for example, a current collector 23A and an active material layer 23B provided on the current collector 23A. Arrangement is made so that the active material layer 23B side is opposed to the active material layer 12. The current collector 23A is made of, for example, aluminum, nickel, or stainless.

The active material layer 23B contains, for example, as a cathode active material, one or more cathode materials capable of inserting and extracting lithium. The active material layer 23B may contain an electrical conductor such as a carbon material and a binder such as polyvinylidene fluoride according to needs. As a cathode material capable of inserting and extracting lithium, for example, a lithium-containing metal complex oxide expressed by a general formula, LiₓMIO₂ is preferable, since thereby a high voltage can be generated and a high density can be obtained, and thus a higher capacity of the secondary battery can be obtained. MI represents one or more transition metals, and is, for example, preferably at least one of cobalt and nickel. x varies according to charge and discharge states of the battery, and is generally in the range of 0.05≦x≦1.10. As a specific example of such a lithium-containing metal complex oxide, LiCoO₂, LiNiO₂ or the like can be cited.

The cathode 23 can be formed as follows, for example. A mixture is prepared by mixing a cathode active material, an electrical conductor, and a binder. The mixture is dispersed in a disperse medium such as N-methyl-2-pyrrolidone to form mixture slurry. The current collector 23A made of a metal foil is coated with the mixture slurry, which is dried and compression-molded to form the active material layer 23B.

The separator 24 separates the anode 10 from the cathode 23, prevents current short circuit due to contact of the both electrodes, and lets through lithium ions. The separator 24 is made of, for example, polyethylene or polypropylene.

An electrolytic solution which is a liquid electrolyte is impregnated in the separator 24. The electrolytic solution contains, for example, a solvent and an electrolyte salt dissolved in the solvent. The electrolytic solution may contain an additive according to needs. As a solvent, for example, a nonaqueous solvent such as ethylene carbonate, propylene carbonate, dimethyl carbonate, diethyl carbonate, and ethyl methyl carbonate can be cited. One of the foregoing solvents may be used singly, or two or more thereof may be used by mixing.

As an electrolyte salt, for example, a lithium salt such as LiPF₆, LiCF₃SO₃, and LiClO₄ can be cited. One of the electrolyte salts may be used singly, or two or more thereof may be used by mixing.

The secondary battery can be manufactured by, for example, layering the anode 10, the separator 24 impregnated with an electrolytic solution, and the cathode 23, inserting the resultant lamination between the package cup 21 and the package can 22, and caulking the package cup 21 and the package can 22.

In the secondary battery, when charged, for example, lithium ions are extracted from the cathode 23 and inserted in the anode 10 through the electrolytic solution. When discharged, for example, lithium ions are extracted from the anode 10 and inserted in the cathode 23 through the electrolytic solution. In this embodiment, the current collector 11 with the ratio I₂₂₀/I₂₀₀ of 2.5 or less at least in part is used for the anode 10. Therefore, even when the active material layer 12 is expanded and shrunk due to charge and discharge, the stress can be relaxed, the current collector 11 can be prevented from being deformed, and separation or the like of the active material layer 12 can be prevented.

The anode 10 according to this embodiment may be used for the following secondary battery.

FIG. 3 shows a structure of the secondary battery. In the secondary battery, a spirally wound electrode body 30 on which leads 31 and 32 are attached is contained inside a film package member 41. Thereby, a small, light, and thin secondary battery can be obtained.

The leads 31 and 32 are respectively directed from inside to outside of the package member 41 and derived in the same direction, for example. The leads 31 and 32 are respectively made of, for example, a metal material such as aluminum, copper, nickel, and stainless, and are in a state of a thin plate or mesh, respectively.

The package member 41 is made of a rectangular aluminum laminated film in which, for example, a nylon film, an aluminum foil, and a polyethylene film are bonded together in this order. The package member 41 is, for example, arranged so that the polyethylene film side and the spirally wound electrode body 30 are opposed to each other, and the respective outer edges are contacted to each other by fusion bonding or an adhesive. Adhesive films 42 to protect from entering of outside air are inserted between the package member 41 and the leads 31 and 32. The adhesive film 42 is made of a material having contact characteristics to the leads 31 and 32, for example, a polyolefin resin such as polyethylene, polypropylene, modified polyethylene, and modified polypropylene.

The package member 41 may be made of a laminated film having other structure, a polymer film such as polypropylene, or a metal film, instead of the foregoing aluminum laminated film.

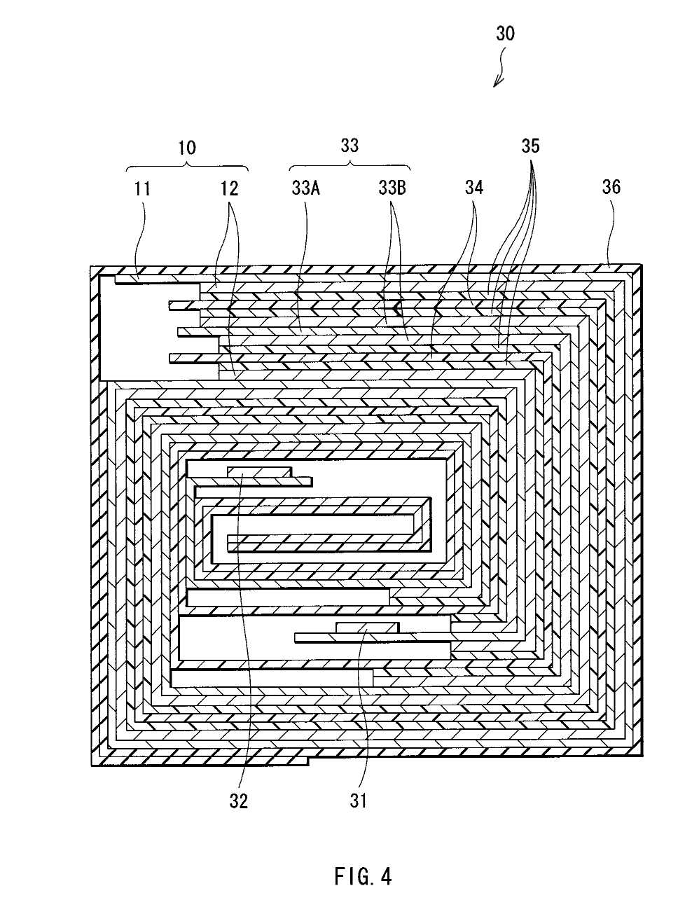

FIG. 4 shows a cross sectional structure taken along line I-I of the spirally wound electrode body 30 shown in FIG. 3. In the spirally wound electrode body 30, the anode 10 and a cathode 33 are layered and spirally wound with a separator 34 and an electrolyte layer 35 in between. The outermost periphery thereof is protected by a protective tape 36.

The anode 10 has a structure in which the active material layer 12 is provided on the both faces of the current collector 11. The cathode 33 also has a structure in which an active material layer 33B is provided on the both faces of a current collector 33A. Arrangement is made so that the active material layer 33B is opposed to the active material layer 12. The structures of the current collector 33A, the active material layer 33B, and the separator 34 are similar to those of the current collector 23A, the active material layer 23B, and the separator 24 respectively described above.

The electrolyte layer 35 is made of a so-called gelatinous electrolyte in which an electrolytic solution is held in a holding body composed of a polymer. The gelatinous electrolyte is preferable, since a high ion conductivity can be thereby obtained, and leakage of the battery can be thereby prevented. The composition of the electrolytic solution is similar to that of the coin-type secondary battery shown in FIG. 2. As a polymer material, for example, polyvinylidene fluoride can be cited.

The secondary battery can be manufactured, for example, as follows.

First, the electrolyte layer 35 in which an electrolytic solution is held in a holding body is formed on the anode 10 and the cathode 33, respectively. Then, the leads 31 and 32 are attached thereto. Next, the anode 10 and the cathode 33 formed with the electrolyte layer 35 are layered and spirally wound with the separator 34 in between. The protective tape 36 is adhered to the outermost periphery thereof to form the spirally wound electrode body 30. Subsequently, for example, the spirally wound electrode body 30 is sandwiched between the package members 41, and outer edges of the package members 41 are contacted by thermal fusion bonding or the like to enclose the spirally wound electrode body 30. Then, the adhesive films 42 are inserted between the leads 31 and 32 and the package member 41. Thereby, the secondary battery shown in FIG. 3 and FIG. 4 is completed.

Otherwise, the secondary battery may be manufactured as follows. First, the leads 31 and 32 are respectively attached to the anode 10 and the cathode 33. After that, the anode 10 and the cathode 33 are layered and spirally wound with the separator 34 in between. The protective tape 36 is adhered to the outermost periphery thereof, and a spirally wound body as a precursor of the spirally wound electrode body 30 is formed. Next, the spirally wound body is sandwiched between the package members 41, and the outermost peripheries except for one side are thermally fusion-bonded to obtain a pouched state. After that, an electrolytic composition containing an electrolytic solution, a monomer as a raw material for a polymer, a polymerization initiator, and if necessary other material such as a polymerization inhibitor is injected into the package member 41. Subsequently, the opening of the package member 41 is thermally fusion-bonded and hermetically sealed in the vacuum atmosphere. Then, the resultant is heated to polymerize the monomer to obtain a polymer. Thereby, the gelatinous electrolyte layer 35 is formed. In the result, the secondary battery shown in FIG. 3 and FIG. 4 is completed.

The actions of the secondary battery are similar to that of the coin-type secondary battery shown in FIG. 2.

As above, according to this embodiment, the current collector 11 which contains copper as an element with the ratio I₂₂₀/I₂₀₀ of 2.5 or less at least in part is used. Therefore, even when the active material layer 12 is largely expanded and shrunk due to charge and discharge, the stress can be relaxed, the current collector 11 can be prevented from being deformed, and the active material layer 12 can be prevented from being separated. In the result, the battery characteristics such as a capacity and cycle characteristics can be improved.

### EXAMPLES

Further, specific examples of the invention will be hereinafter described in detail with reference to the drawings.

### Examples 1 to 17

The secondary batteries shown in FIGS. 3 and 4 were fabricated.

First, the current collector 11 made of a copper foil was prepared. Then, in Examples 1 to 17, the ratio I₂₂₀/I₂₀₀ of the current collector 11 was changed by using manufacturing methods different from each other. For the current collector 11 of Examples 1 to 17, X-ray diffraction measurement was performed to examine the ratio I₂₂₀/I₂₀₀. As a measurement apparatus, an X-ray apparatus of Rigaku Corporation was used. The X-ray tube was CuKa, the tube voltage was 40 kV, the tube current was 40 mA, the scanning method was θ-2θ method, and the measurement range was 20 deg-80 deg. Based on the obtained X-ray diffraction pattern, the ratio I₂₂₀/I₂₀₀ was obtained from the peak area I₂₂₀ resulting from the (220) crystal face of copper observed in the vicinity of 74.1 deg and the peak area I₂₀₀ resulting from the (200) crystal face of copper observed in the vicinity of 50.4 deg. The obtained results are shown in Table 1.

Next, the active material layer 12 containing silicon being about 5 μm thick was formed on the current collector 11 by sputtering method to form the anode 10. Further, the active material layer 12 was formed by coating the current collector 11 of Examples 1 to 17 with silicon powder with an average particle diameter of 2 μm and pressing the resultant, and thereby the anode 10 was formed. For the formed respective anodes 10, X-ray diffraction measurement was performed to examine the ratio I₂₂₀/I₂₀₀. The almost same results as those before forming the active material layer 12 were obtained.

Further, lithium cobaltate (LiCoO₂) powder with an average particle diameter of 5 μm as a cathode active material, carbon black as an electrical conductor, and polyvinylidene fluoride as a binder were mixed. A resultant mixture was put in N-methyl-2-pyrrolidone as a disperse medium to obtain slurry. Next, the current collector 33A made of an aluminum foil being 15 μm thick was coated with the slurry, which was dried and pressed to form the active material layer 33B.

Subsequently, 37.5 wt % of ethylene carbonate, 37.5 wt % of propylene carbonate, 10 wt % of vinylene carbonate, and 15 wt % of LiPF₆ were mixed to prepare an electrolytic solution. The both faces of the anode 10 and the cathode 33 were respectively coated with a mixture obtained by mixing the electrolytic solution and polyvinylidene fluoride as a block copolymer with weight average molecular weight of 0.6 million to form the electrolyte layer 35. After that, the leads 31 and 32 were attached, the anode 10 and the cathode 33 were layered and spirally wound with the separator 34 in between, and the resultant body was enclosed in the package member 41 made of an aluminum laminated film. Thereby, the secondary batteries of Examples 1 to 17 were obtained.

As Comparative examples 1 to 5 relative to Examples 1 to 17, secondary batteries were fabricated in the same manner as in Examples 1 to 17, except that current collectors with the ratio I₂₂₀/I₂₀₀ different from those of Examples 1 to 17 were used. For the current collectors of Comparative examples 1 to 5, the ratio I₂₂₀/I₂₀₀ was examined in the same manner as in Examples 1 to 17. The results are shown in Table 2.

For the fabricated secondary batteries of Examples 1 to 17 and Comparative examples 1 to 5, charge and discharge test was performed at 25 deg C., and the capacity retention ratio at the 50th cycle to the second cycle was obtained. Then, charge was performed until the battery voltage reached 4.2 V at a constant current density of 1 mA/cm², and then performed until the current density reached 0.05 mA/cm² at a constant voltage of 4.2 V. Discharge was performed until the battery voltage reached 2.5 V at a constant current density of 1 mA/cm². Charge was performed so that a utility ratio of the capacity of the anode 10 became 90% to prevent metal lithium from being precipitated on the anode 10. The capacity retention ratio was calculated as a ratio of the discharge capacity at the 50th cycle to the discharge capacity at the second cycle, that is, as (the discharge capacity at the 50th cycle/the discharge capacity at the second cycle)×100. The results are shown in Table 1.

Further, for the secondary batteries of Examples 1 to 17, the secondary batteries were disassembled and the anodes 10 were taken out after repeating charge and discharge 50 cycles. X-ray diffraction measurement was performed and the ratio I₂₂₀/I₂₀₀ was examined. The almost same results as the values shown in Table 1 were obtained

TABLE 1

| | | Capacity retention ratio (%) | |
|---|---|---|---|
| | Current | Active material | Active material |
| | collector | layer formed | layer formed |
| | I₂₂₀/I₂₀₀ | by sputtering | by coating |
| Example 1 | 2.423 | 76 | 76 |
| Example 2 | 2.246 | 78 | 76 |
| Example 3 | 1.629 | 81 | 77 |
| Example 4 | 1.548 | 82 | 77 |
| Example 5 | 0.99 | 83 | 75 |
| Example 6 | 0.785 | 84 | 77 |
| Example 7 | 0.757 | 86 | 78 |
| Example 8 | 0.431 | 87 | 80 |
| Example 9 | 0.411 | 86 | 79 |
| Example 10 | 0.361 | 89 | 80 |
| Example 11 | 0.335 | 89 | 81 |
| Example 12 | 0.208 | 90 | 80 |
| Example 13 | 0.194 | 88 | 80 |
| Example 14 | 0.155 | 91 | 80 |
| Example 15 | 0.035 | 82 | 78 |
| Example 16 | 0.023 | 73 | 75 |
| Example 17 | 0.011 | 74 | 75 |
| Comparative example 1 | 7.147 | 50 | 73 |
| Comparative example 2 | 6.554 | 44 | 72 |
| Comparative example 3 | 3.323 | 29 | 71 |
| Comparative example 4 | 3.174 | 55 | 69 |
| Comparative example 5 | 2.782 | 68 | 72 |

As shown in Table 1, according to Examples 1 to 17 in which the current collector 11 with the ratio I₂₂₀/I₂₀₀ of 2.5 or less was used, the capacity retention ratio could be improved compared to Comparative examples 1 to 5 in which the current collector with the ratio I₂₂₀/I₂₀₀ larger than 2.5 was used. Further, the improvement degree was larger in the case that the active material layer 12 was formed by sputtering method than in the case that the active material layer 12 was formed by coating.

Further, some secondary batteries were taken out from the secondary batteries of Examples and Comparative examples, and a relation between the elongation percentage/the tensile strength of the current collector 11 and the capacity retention ratio was examined. The results are shown in Table 2. In Table 2, the upper frame shows elongation percentages in descending order, and the lower frame shows tensile strengths in descending order.

TABLE 2

| | Elongation | | Current | Capacity |
|---|---|---|---|---|
| | percentage | Tensile strength | collector | retention (%) |
| | (%) | (N/mm²) | I₂₂₀/I₂₀₀ | (sputtering) |
| Comparative | 15 | 352 | 2.782 | 68 |
| example 5 | | | | |
| Example 11 | 12.5 | 258 | 0.335 | 89 |
| Comparative | 12.3 | 392 | 6.554 | 44 |
| example 2 | | | | |
| Example 9 | 9.2 | 354 | 0.411 | 86 |
| Example 12 | 7 | 333 | 0.28 | 90 |
| Comparative | 6 | 320 | 3.174 | 55 |
| example 4 | | | | |
| Example 17 | 2 | 440 | 0.011 | 72 |
| Example 16 | 1.5 | 260 | 0.023 | 73 |
| Example 17 | 2 | 440 | 0.011 | 72 |
| Comparative | 12.3 | 392 | 6.554 | 44 |
| example 2 | | | | |
| Example 9 | 9.2 | 354 | 0.411 | 86 |
| Comparative | 15 | 352 | 2.782 | 68 |
| example 5 | | | | |
| Example 12 | 7 | 333 | 0.28 | 90 |
| Comparative | 6 | 320 | 3.174 | 55 |
| example 4 | | | | |
| Example 16 | 1.5 | 260 | 0.023 | 73 |
| Example 11 | 12.5 | 258 | 0.335 | 89 |

As shown in Table 2, no relation was found between the elongation percentage/the tensile strength and the capacity retention ratio. For example, Comparative example 5 and Example 9 have the tensile strength almost similar to each other. However, though Comparative example 5 has the elongation percentage of 15%, which is higher than that of Example 9, Example 9 with smaller elongation percentage shows a higher capacity retention ratio. Further, Comparative example 2 and Example 11 have the elongation percentage almost similar to each other. However, though Comparative example 2 has the tensile strength of 392 N/mm², which is higher than that of Example 11, Example 11 with a smaller tensile strength shows a higher capacity retention ratio.

That is, it was found that when the current collector 11 containing copper as an element and having the ratio I₂₂₀/I₂₀₀ of 2.5 or less at least in part was used, stress could be relaxed, and the battery characteristics such as a capacity and cycle characteristics could be improved. Further, it was found that at least part of the active material layer 12 was formed by vapor-phase deposition method such as sputtering, higher effects could be obtained.

The invention has been described with reference to the embodiment and the examples. However, the invention is not limited to the foregoing embodiment and the foregoing examples, and various modifications may be made. For example, in the foregoing embodiment and the foregoing examples, descriptions have been given of the case using the electrolytic solution as a liquid electrolyte or the gelatinous electrolyte. However, other electrolyte may be used. As other electrolyte, a solid electrolyte having ion conductivity, a mixture of a solid electrolyte and an electrolytic solution, or a mixture of a solid electrolyte and a gelatinous electrolyte can be cited.

As a solid electrolyte, for example, a polymer solid electrolyte in which an electrolyte salt is dispersed in a polymer having ion conductivity, or an inorganic solid electrolyte formed of ion conductive glass, ionic crystal or the like can be used. As a polymer of the polymer solid electrolyte, for example, an ether polymer such as polyethylene oxide and a cross-linked body containing polyethylene oxide, an ester polymer such as poly methacrylate, or an acrylate polymer can be used singly, by mixing, or by copolymerization. As an inorganic solid electrolyte, a substance containing lithium nitride, lithium phosphate or the like can be used.

Further, in the foregoing embodiment and the foregoing examples, descriptions have been given of the coin type secondary battery and the spirally wound laminated type secondary battery. However, the invention can be similarly applied to a secondary battery having other shape such as a cylinder type secondary battery, a square type secondary battery, a button type secondary battery, a thin secondary battery, a large secondary battery, and a laminated type secondary battery. Further, the invention can be applied to primary batteries in addition to the secondary batteries.

It should be understood by those skilled in the art that various modifications, combinations, sub-combinations and alternations may occur depending on design requirements and other factors insofar as they are within the scope of the appended claims or the equivalents thereof.

What is claimed is:

1. A current collector containing copper (Cu) as an element,
wherein where a peak area resulting from (220) crystal face of copper obtained by X-ray diffraction is I₂₂₀, and a peak area resulting from (200) crystal face of copper obtained by X-ray diffraction is I₂₀₀, ratio I₂₂₀/I₂₀₀ as a ratio of the peak area I₂₂₀ to the peak area I₂₀₀ is 2.5 or less at least in part.

2. The current collector according to claim 1, wherein the ratio I₂₂₀/I₂₀₀ is from 0.03 to 2.5 at least in part.

3. An anode provided with an active material layer on a current collector,
wherein the current collector contains copper (Cu) as an element, and
where a peak area resulting from (220) crystal face of copper obtained by X-ray diffraction is I₂₂₀, and a peak area resulting from (200) crystal face of copper obtained by X-ray diffraction is I₂₀₀, ratio I₂₂₀/I₂₀₀ as a ratio of the peak area I₂₂₀ to the peak area I₂₀₀ is 2.5 or less at least in part.

4. The anode according to claim 3, wherein the ratio I₂₂₀/I₂₀₀ is from 0.03 to 2.5 at least in part.

5. The anode according to claim 3, wherein the current collector and the active material layer are alloyed in at least part of the interface thereof.

6. The anode according to claim 3, wherein at least part of the active material layer is formed by one or more methods selected from the group consisting of vapor-phase deposition method, spraying method, and firing method.

7. The anode according to claim 3, wherein the active material layer contains silicon (Si) as an element.

8. A battery comprising:
a cathode;
an anode;
and an electrolyte,
wherein the anode has a current collector and an active material layer,
the current collector contains copper (Cu) as an element, and
where a peak area resulting from (220) crystal face of copper obtained by X-ray diffraction is I₂₂₀, and a peak area resulting from (200) crystal face of copper obtained by X-ray diffraction is I₂₀₀, ratio I₂₂₀/I₂₀₀ as a ratio of the peak area I₂₂₀ to the peak area I₂₀₀ is 2.5 or less at least in part.

9. The battery according to claim 8, wherein the ratio I₂₂₀/I₂₀₀ is from 0.03 to 2.5 at least in part.

10. The batter, according to claim 8, wherein the current collector and the active material layer are alloyed in at least part of the interface thereof.

11. The battery according to claim 8, wherein at least part of the active material layer is formed by one or more methods selected from a group consisting of vapor-phase deposition method, spraying method, and firing method.

12. The battery according to claim 8, wherein the active material layer contains silicon (Si) as an element.
